(19) United States
(12) Patent Application Publication
(10) Pub. No.: US 2010/0316816 A1
(43) Pub. Date: Dec. 16, 2010

(54) DOUBLE-SIDED PRESSURE-SENSITIVE ADHESIVE TAPES FOR PRODUCING LC-DISPLAYS HAVING LIGHT-REFLECTING AND ABSORBING PROPERTIES

(75) Inventors: Marc Husemann, Hamburg (DE); Claus Meyer, Hamburg (DE); Matthias Koch, Hamburg (DE); Gabriel Dalmis, Hamburg (DE)

Correspondence Address: Briscoe, Kurt G.;Norris McLaughlin & Marcus, PA, 875 Third Avenue, 8th Floor, New York, NY, 10022, US

(73) Assignee: Tesa SE, HAMBURG (DE)

(21) Appl. No.: 12/095,634

(22) PCT Filed: Dec. 2, 2005
(86) PCT No.: PCT/EP05/56422

§ 371 Date: Sep. 1, 2010

(51) Int. Cl. C09J 7/02; B32B 7/12; B32B 15/08; B32B 27/06; G02F 1/133

(52) U.S. Cl. 428/1.5; 428/344; 156/313

(57) ABSTRACT

A pressure-sensitive adhesive tape having pressure-sensitive adhesive layers on a top side and a bottom side, and a carrier film between the adhesive layers, wherein there is a white coating layer at least between the pressure-sensitive adhesive layer on the top side and the carrier film and there is a metallic layer at least between the pressure-sensitive adhesive layer on the bottom side and the carrier film. The pressure-sensitive adhesive tape is useful to bonding parts of optical liquid crystal displays. Optical liquid crystal displays containing the pressure-sensitive adhesive tape are also disclosed.

This application is a 371 of PCT/EP2005/056422 filed Dec. 2, 2005.

The invention relates to double-sided pressure-sensitive adhesive tapes having multilayer carrier constructions, having multilayer pressure-sensitive adhesive constructions, and having light-reflecting and light-absorbing properties for producing liquid-crystal data displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties.

One field of use is that of optical liquid-crystal data displays (LCDs) which are needed for computers, TVs, laptops, PDAs, cellphones, digital cameras, etc. FIG. 1 shows the approach for a double-sided adhesive tape having a black layer for absorption and a layer for reflection, in accordance with the prior art; the key to the reference numerals is as follows:
1 LCD glass
2 double-sided black-white adhesive tape
3 pressure-sensitive adhesive
4 light source (LED)
5 light beams
6 double-sided adhesive tape
7 optical waveguide
8 reflective film
9 LCD casing
10 black absorbing side of adhesive tape
11 reflecting side
12 visible region
13 “blind” region

For the production of LC displays, LEDs (light-emitting diodes), as the light source, are bonded to the LCD module. In general, black, double-sided pressure-sensitive adhesive tapes are used for this purpose. The aim of the black coloration is to prevent light penetrating from inside to outside and vice versa in the region of the double-sided pressure-sensitive adhesive tape.

There are already numerous approaches in existence for achieving such black coloring. On the other hand, there is a desire to increase the light efficiency of the back light module, and so it is preferred to use double-sided adhesive tapes which are black (light-absorbing) on one side and light-reflecting on the other side.

In the development of LC displays there is a trend developing. On the one hand, the LC displays are to become more lightweight and also flatter, and there is a rising demand for ever larger displays with ever higher resolution.

For this reason, the design of the displays has been changed, and the light source, accordingly, is coming nearer and nearer to the LCD panel, with the consequence of an increased risk of more and more light penetrating from outside into the marginal zone (“blind area”) of the LCD panel (see FIG. 1). With this development, therefore, there is also an increase in the requirements imposed on the shading properties (blackout properties) of the double-sided adhesive tape, and accordingly there is a need for new approaches for adhesive tapes.

Known for this purpose are double-sided pressure-sensitive adhesive tapes which have a black carrier and a metallic layer on one side. With these pressure-sensitive adhesive tapes, a distinct improvement has been obtained in respect of light reflection on one side and absorption on the opposite side.

DE 102 43 215 describes double-sided adhesive tapes for LC displays that have light-absorbing properties on the one side and light-reflecting properties on the other side. That patent describes black/silver double-sided PSA tapes. A transparent or colored carrier film is metallized on one side and colored black on the other side. In this way the reflecting properties achieved are already good, but the absorbing properties are still deficient, since defects, arising for example from the film as a result of antiblocking agents, are only coated over, and hence the light can still shine through at these points (pinholes).

For the adhesive bonding of LC displays, however, there continues to be a need for light-reflecting and absorbing properties, where for light absorption the adhesive tapes shall not have a black layer.

It is therefore an object of the invention to provide a double-sided pressure-sensitive adhesive tape which avoids the presence of pinholes, which is capable of fully absorbing light, which has no black side for light absorption, and which features improved reflection of light.

This object is achieved by means of the pressure-sensitive adhesive tapes of the invention as described hereinbelow. In the context of this invention it has surprisingly been found that, using a film which on at least one side is metallized and has been provided at least with a white coating layer, these properties can be achieved.

The present invention relates, accordingly, to a pressure-sensitive adhesive tape, in particular for the production or adhesive bonding of optical liquid-crystal data displays (LCDs), having a top side and a bottom side, having light-reflecting properties on the top and bottom sides and, at the same time, light-absorbing properties by virtue of the carrier construction, with one side being white and the other side being silver-colored.

The invention more particularly provides a pressure-sensitive adhesive tape, in particular for the production or adhesive bonding of optical liquid-crystal data displays (LCDs), having light-reflecting and light-absorbing properties, having a top side and a bottom side, additionally having a carrier film, which in turn has a top side and a bottom side, the pressure-sensitive adhesive tape being equipped on both sides with a pressure-sensitive adhesive layer, characterized in that, at least between the pressure-sensitive adhesive layer on the bottom side of the pressure-sensitive adhesive tape and the carrier film there is a silver-colored, in particular metallic layer, and, at least between the pressure-sensitive adhesive layer on the top side of the pressure-sensitive adhesive tape and the carrier film, there is a white coating layer.

Set out below are certain advantageous embodiments of the adhesive tape of the invention, without any wish to be restricted unnecessarily through the choice of the examples.

The pressure-sensitive layers (b) and (b′) on the two sides of the pressure-sensitive adhesive tape of the invention can in each case be identical or different, more particularly with regard to their configuration (layer thickness and the like) and their chemical composition. With particular preference the PSA on both sides of the pressure-sensitive adhesive tape is transparent. In the inventive sense, however, it can also be advantageous to color the PSAs white on the white side of the pressure-sensitive adhesive tape.

### BRIEF DESCRIPTION OF THE DRAWINGS

The invention will now be described in greater detail with reference to the drawings, wherein:

FIG. 1 is a schematic showing a conventional approach to bonding parts of an LCD display;

FIG. 2 is a schematic depicting one embodiment of an adhesive tape according to the present invention; and

FIG. 3 is a schematic depicting a second embodiment of an adhesive tape according to the present invention.

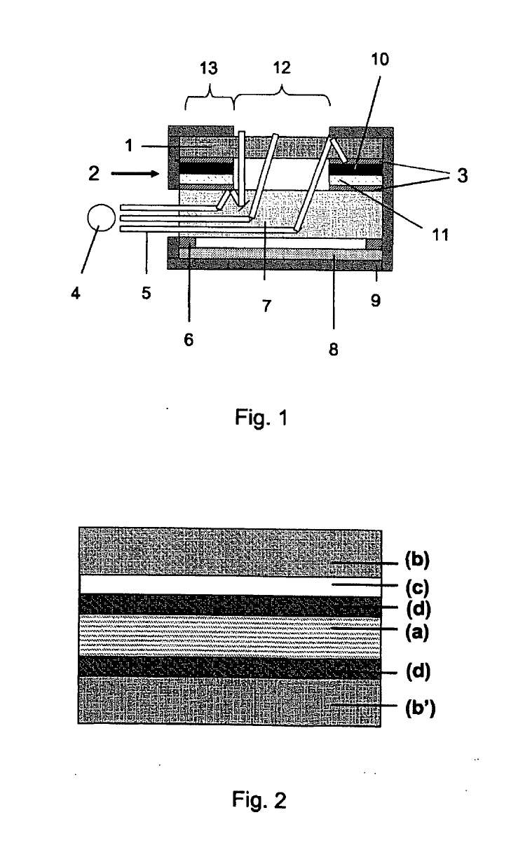

In a first advantageous embodiment the inventive pressure-sensitive adhesive tape is composed of a carrier film layer (a), a white chromophoric coating layer (c), two silver-colored, in particular metallic layers (d) and two transparent pressure-sensitive adhesive layers (b) and b′). This embodiment is depicted in FIG. 2.

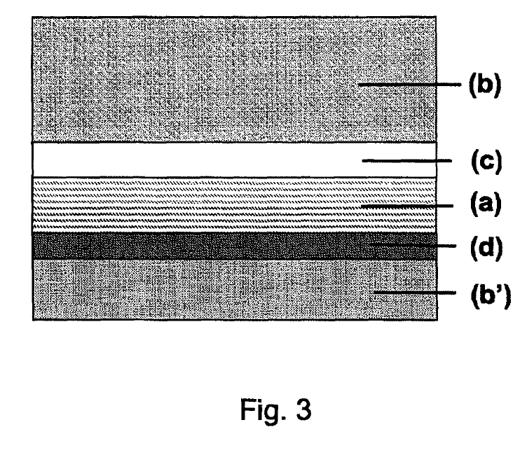

In a further preferred embodiment of the invention, as shown by FIG. 3, the double-sided pressure-sensitive adhesive tape is composed of a carrier film (a), a white chromophoric coating layer (c), a silver-colored, in particular metallic layer (d), and two pressure-sensitive adhesive layers (b) and (b′).

The invention is elucidated further below. The limiting values specified should be understood as inclusive values, in other words as included within the stated limiting range.

The carrier film (a) is preferably between 5 and 250 μm, more preferably between 8 and 50 μm, most preferably between 12 and 36 μm thick and preferably transparent, white or semitransparent. The film, however, may also be differently colored, in order to reduce the light transmittance of the adhesive tape. The coating layers (c) are light-reflecting and at the same time light-absorbing.

The thickness of the coating layers (c) lies preferably between 1 μm and 15 μm. In the sense of layer (c) there may also be two or more coating layers lying one atop another. The layer thickness of the silver-colored, in particular metallic layer(s) (d) is preferably between 0.01 μm and 5 μm. Here, in one particularly preferred version, aluminum or silver is vapor-coated onto the carrier film (a).

The PSA layers (b) and (b′) preferably possess a thickness of in each case between 5 μm and 250 μm. Within the double-sided pressure-sensitive adhesive tape the thickness of the individual layers (a), (c), (b), and (b′) may be different, so that, for example, it is possible to apply PSA layers (b) and (b′) of different thicknesses, or else individual layers, two or more layers or else all the layers may be chosen identically.

### Carrier Film (a)

As film carriers it is possible in principle to use all film-like polymer carriers, more particularly those which are transparent, semitransparent or colored. Thus it is possible, for example, to use polyethylene, polypropylene, polyimide, polyester, polyamide, polymethacrylate, fluorinated polymer films, etc. In one particularly preferred embodiment, polyester films are used, more preferably PET (polyethylene terephthalate) films. The films may be present in detensioned form or may have one or more preferential directions. Preferential directions are obtained by drawing in one or in two directions. Normally for the production process for films, PET films, for example, antiblocking agents, such as silicon dioxide, siliceous chalk or other chalk, or zeolites, are used.

Antiblocking agents are intended to prevent the sticking together of flat polymeric films under pressure and temperature to form blocks. Typically the antiblocking agents are incorporated into the thermoplastic mix. In that case the particles function as spacers.

Films of this kind can be used with advantage for the inventive double-sided adhesive tapes. For the inventive pressure-sensitive adhesive tapes, however, it is also possible to use films which contain no antiblocking agents or contain them only in a very small fraction. One example of such films is, for example, the Hostaphan™ 5000 series from Mitsubishi Polyester Film (PET 5211, PET 5333, PET 5210).

Furthermore, very thin films, 6 or 12 μm thick for example, are preferred, since they allow very good technical adhesive properties for the double-sided adhesive tape, because in this case the film is very flexible and is able to conform well to the surface roughnesses of the substrates to be bonded.

For improving the anchorage of the coating layers it is very advantageous if the films are pretreated. The films may have been etched (e.g., trichloroacetic acid or trifluoroacetic acid), pretreated by corona or plasma, or furnished with a primer (e.g., Saran).

A further and advantageous possibility—particularly if the film material is transparent or semitransparent—is to add color pigments or chromophoric particles to the film material. Thus, for example, titanium dioxide and barium sulfate are suitable for white coloration. The pigments or particles ought preferably, however, always to be smaller in diameter than the final layer thickness of the carrier film. Optimum colorations can be obtained using 10% to 40% by weight particle fractions, based on the film material.

### Coating Layer (c)

The coating layer (c) fulfills a variety of functions. In one version of the invention a function of the color layer is the additional adsorption of external light. In this case, therefore, for the double-sided pressure-sensitive adhesive tape the transmittance in a wavelength range of 300 to 800 nm ought to be situated at <0.5%, more preferably at <0.1%, most preferably at <0.01%.

The coating layer (c) further fulfills the function of light reflection. The light reflection according to test method c ought to be greater than 65%.

In one very preferred version this is achieved using a white coating layer.

Coating materials can be coated as 100% systems, from solution or from dispersion. Coating materials are composed of a curing binder matrix (preferably a thermosetting system, or alternatively radiation-curing system) and white color pigments and are then applied using a printing unit (by flexographic printing, for example). In order to achieve sufficient opacity, application may also take place in two or more steps, so that two or more layers of printing ink are applied. Moreover, the ink can also be applied using an engraved-roll applicator unit. In this way it is possible to apply relatively high ink layer thicknesses in one step.

The coating materials may be based, for example, on polyesters, polyurethanes, polyacrylates or polymethacrylates. Additionally it is possible for coatings additives known to the skilled worker to have been added. The coating material further contains a crosslinking component for curing, which can be activated either by radiation curing (electron beam curing, by means for example of difunctional or polyfunctional vinylic compounds; UV curing, for example in conjunction with UV photocation generators, difunctional or polyfunctional epoxides, or by means of UV free-radical initiators of Norrish I or Norrish II type, in turn difunctional or polyfunctional vinylic compounds, such as acrylates or methacrylates, for example) or by means of thermally activable compounds, such as difunctional or polyfunctional isocyanates, difunctional or polyfunctional epoxides, difunctional or polyfunctional hydroxides for example, in accordance with dependence on the base matrix of the coating material.

In one inventive version which is very much to be preferred, chromophoric particles mixed into the coating layer are titanium dioxide or barium sulfate. At a very high level of additization (preferably >20% by weight), this additization not only produces the function of complete light absorption but also effects light reflection. For the optimum coloring of the coating layer (c) the particle size distribution of the white color pigments is very important. Thus the particles ought at least to be smaller than the total thickness of the coating layer (c). One preferred version uses particles having an average diameter of 50 nm to 5 μm, more preferably between 100 nm and 3 μm, most preferably between 200 nm and 1 μm. Grades of this kind can be obtained, for example, by controlled milling in ball mills, with subsequent controlled screening. The quality of the coloration further necessitates homogeneous distribution of the color particles in the coating layer. For this purpose it is necessary to employ an intense mixing operation, which in one optimum version constitutes a mixing operation using the Ultraturrax. With this step, then, the color particles can once again be broken down and homogenized in the white coating material.

### Silver-Colored or Metallic Layer (d)

For the production of a high-reflectivity and light-absorbing side, either a silver-colored coating material can be applied to the film layer (a), or the film layer (a) can be vapor-coated on one or both sides with a metal, aluminum or silver for example. For the version involving silver-colored coating material, a binder matrix is blended with silver color pigments. Examples of suitable binder matrices include polyurethanes or polyesters which have a high refractive index and a high transparency. Alternatively the color pigments can be bound up into a polyacrylate or polymethacrylate matrix and then cured in the form of coating material.

In one very preferred version the film layer (a) is vapor-coated on both sides with aluminum or silver. In order to achieve particularly outstanding reflecting properties, the sputtering operation for vapor coating ought to be controlled in such a way that the aluminum or silver is applied very uniformly, in order to obtain optimum reflection (avoidance of scattering effects). Furthermore, in one very preferred embodiment, the PET film is pretreated by plasma or corona before being vapor-coated with aluminum or silver. Through the use of the reflecting layer (d), on the one hand the light is reflected in a targeted way, and on the other hand the transmission of the light through the carrier material is reduced or avoided, and also surface roughnesses on the part of the carrier film are compensated.

PSAs (b) and (b′)

The PSAs (b) and (b′) are in one preferred embodiment identical on both sides of the PSA tape. In one specific embodiment, however, it may also be of advantage if the PSAs (b) and (b′) differ from one another, in particular in their layer thickness and/or their chemical composition. Thus in this way it is possible, for example, to set different pressure-sensitive adhesion properties. PSA systems employed for the inventive double-sided pressure-sensitive adhesive tape are preferably acrylate adhesives, natural-rubber adhesives, synthetic-rubber adhesives, silicone adhesives or EVA adhesives. The PSA has a high transparency or is colored white.

Furthermore it is also possible to process the further PSAs that are known to the skilled worker, as are cited for example in the “Handbook of Pressure Sensitive Adhesive Technology” by Donatas Satas (van Nostrand, New York 1989).

For natural-rubber adhesives the natural rubber is milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV grades, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made of (meth)acrylate PSAs.

(Meth)acrylate PSAs used in accordance with the invention, which are obtainable by free-radical addition polymerization, consist preferably to the extent of at least 50% by weight of at least one acrylic monomer from the group of the compounds of the following general formula:

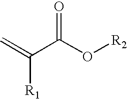

Here the radical R₁ is H or CH₃; and the radical R₂ is H or CH₃ or is selected from the group containing branched and unbranched, saturated alkyl groups having 1-30 carbon atoms.

The monomers are preferably chosen such that the resulting polymers can be used, at room temperature or higher temperatures, as PSAs, more particularly such that the resulting polymers possess pressure-sensitive adhesive properties in accordance with the “Handbook of Pressure Sensitive Adhesive Technology” by Donatas Satas (van Nostrand, New York 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁ is H or CH₃ and R₂ is an alkyl chain having 1-20 C atoms or is H.

The molar masses M_{w} (weight average) of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 C atoms, and preferably comprise 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethyl-hexyl acrylate, 2-ethylhexyl methacrylate, isooctyl acrylate, and isooctyl methacrylate, for example.

Further classes of compound to be used are monofunctional acrylates and/or methacrylates of bridged cycloalkyl alcohols consisting of at least 6 C atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In one advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in one advantageous procedure, use is made of photoinitiators having a copolymerizable double bond. Suitable photoinitiators include Norrish I and Norrisch II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA as a result, for example, of extraneous light is minimized.

For further development it is possible to admix resins to the PSAs. As tackifying resins for addition it is possible to use the tackifier resins already known and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989). Here as well, the transparency is improved using, preferably, transparent resins which are very highly compatible with the polymer. Hydrogenated or partly hydrogenated resins frequently feature these properties.

In addition it is possible optionally to add plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers.

In a further favorable embodiment of the invention the PSA (b) and/or (b′) comprises light-reflecting particles, such as white color pigments (titanium dioxide or barium sulfate), for example, as a filler.

In addition it is possible to admix crosslinkers and promoters to the PSAs (b) and/or (b′) for crosslinking. Examples of suitable crosslinkers for electron beam crosslinking and UV crosslinking include difunctional or polyfunctional acrylates, difunctional or polyfunctional isocyanates (including those in block form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geige®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for the Acrylate PSAs

For the polymerization the monomers are chosen such that the resultant polymers can be used at room temperature or higher temperatures as PSAs, particularly such that the resulting polymers possess pressure-sensitive adhesive properties in accordance with the “Handbook of Pressure Sensitive Adhesive Technology” by Donatas Satas (van Nostrand, New York 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with an equation (eE1) analogous to the Fox equation (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred embodiment the free-radical initiator used is 1,1′-azobis(cyclohexane-carbonitrile) (Vazo 88™ from DuPont) or azodiisobutyronitrile (AIBN).

The weight-average molecular weights M_{w} of the PSAs formed in the free-radical polymerization are very preferably chosen such that they are situated within a range of 200 000 to 4 000 000 g/mol; in particular, PSAs are prepared which have average molecular weights M_{w} of 400 000 to 1 400 000 g/mol for the further use as an electrically conductive hot-melt PSA with the capacity for resetting. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are straight alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether), and ethers (e.g. diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

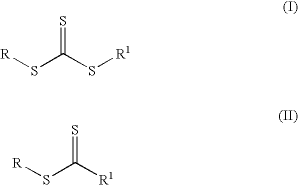

in which R and R¹ are chosen independently of one another or are identical, and
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following further-restricted compounds: halogen atoms therein are preferably F, Cl, Br or I, more preferably Cl and Br.

Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethylphenyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

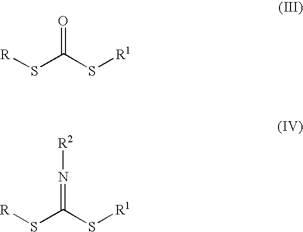

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hot-melt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

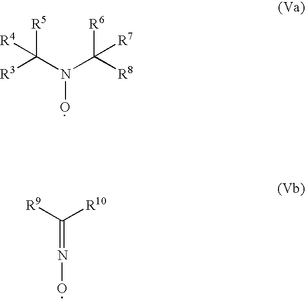

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of the formulae (Va) or (Vb) can also be attached to polymer chains of any kind (primarily such that at least one of the abovementioned radicals constitutes a polymer chain of this kind) and may therefore be used for the synthesis of polyacrylate PSAs.

With greater preference, use is made of controlled regulators for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses.

WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed.

WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, Contribution to the National Meeting of the American Chemical Society, Spring 1997; Husemann, Contribution to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process, Treatment of the Carrier Material

For production, in one preferred embodiment the pressure-sensitive adhesive is coated from solution onto the carrier material. To increase the anchoring of the PSA it is possible optionally to pretreat the layer (a). Thus pretreatment may be carried out, for example, by corona or by plasma.

For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the production process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one advantageous embodiment the PSAs are coated by a roll coating process. Different roll coating processes are described in the “Handbook of Pressure Sensitive Adhesive Technology”, by Donatas Satas (van Nostrand, New York 1989). In another embodiment, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels.

Through the coating it is also possible for the PSAs to undergo orientation.

In addition it may be necessary for the PSA to be crosslinked. In one preferred embodiment, crosslinking takes place thermally with electronic and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention, the PSAs are crosslinked using electron beams. Typical irradiation equipment which can be employed includes linear cathode systems, scanner systems, and segmented cathode systems, where electron beam accelerators are employed. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 and 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for the adhesive bonding or production of LC displays. For use as pressure-sensitive adhesive tape it is possible for the double-sided pressure-sensitive adhesive tapes to have been lined with one or two release films and/or release papers. In a preferred embodiment, use is made of siliconized or fluorinated films or papers, such as glassine, HDPE or LDPE coated papers, for example, which have in turn been given a release coat based on silicones or fluorinated polymers. In one particularly preferred embodiment the lining used comprises siliconized PET films.

The pressure-sensitive adhesive tapes of the invention are suitable with particular advantage for adhesively bonding light-emitting diodes (LEDs), as the light source, to the LCD module.

### EXAMPLES

The invention is described below, without wishing any unnecessary restriction to result from the choice of the examples.

The following test methods were employed.

Test methods

### A. Transmittance

The transmittance was measured in the wavelength range from 190 to 900 nm using a Uvikon 923 from Biotek Kontron. The measurement is conducted at 23° C. The absolute transmittance is reported as a value at 550 nm in % relative to complete light absorption (0% transmittance=no light let through; 100%=light let through completely).

### B. Pinholes

A very strong light source of commercially customary type (e.g., Liesegangtrainer 400 KC type 649 overhead projector, 36 V halogen lamp, 400 W) is given completely lightproof masking. This mask contains in its center a circular aperture having a diameter of 5 cm. The double-sided LCD adhesive tape is placed atop said circular aperture. In a completely darkened environment, the number of pinholes is then counted electronically or visually. When the light source is switched on, these pinholes are visible as translucent dots.

### C. Reflectance

The reflection test is carried out in accordance with DIN standard 5036 part 3, DIN 5033, part 3, and DIN 5033 part 4. The instrument used was an LMT-type Ulbricht sphere (50 cm diameter), in conjunction with an LMT-typeTau-ρ-Meter digital display device. The integral measurements are made using a light source corresponding to standard light A and V(λ)-adapted Si photoelement. Measurement was carried out against a glass reference sample. The reflectance is reported as the sum of directed and scattered light fractions in %.

### Polymer 1

A 200 I reactor conventional for free-radical polymerizations was charged with 2400 g of acrylic acid, 64 kg of 2-ethylhexyl acrylate, 6.4 kg of methyl acrylate and 53.3 kg of acetone/isopropanol (95:5). After nitrogen gas had been passed through the reactor for minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature. Before the composition is used for coating, the polymer 1 is diluted with isopropanol to 30% solids content. Subsequently, with vigorous stirring, 0.3% by weight of aluminum(III) acetylacetonate (3% strength solution, isopropanol), based on the polymer 1, is mixed in.

### Film (Al Vapor Coating):

A PET film 12 μm or 38 μm thick (12 μm, for example, from Mitsubishi (Hostaphan™ 5210; 38 μm, for example, from Toray Lumirror™ 38E20) is vapor-coated on one or both sides with aluminum until an aluminum layer had been applied over the entire area. The film was vapor-coated in a width of 300 mm by the sputtering process. Here, positively charged, ionized argon gas is passed into a high-vacuum chamber. The charged ions then strike a negatively charged Al plate and, at the molecular level, detach particles of aluminum, which then deposit on the polyester film which is passed above the plate.

### Coating Material 1

In a Red Devil paint mixer, 42 parts of Acrydic A-109 (nitrogen-containing acrylic resin with a solids content of 50% from Dainippon Ink and Chemicals), 80 parts of titanium white JR603 (Teikoku Kako Co. Ltd.), 6 parts of xylene, 6 parts of toluene and 6 parts of methyl ether ketone are dispersed for 30 minutes. Homogenization is then continued in an Ultraturrax.

### Example 1

A Meyer bar is used to apply the coating composition 1 evenly to the 12 μm PET film, aluminized on both sides, and the applied coating is dried at 120° C. for 10 minutes. The application weight is 10 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. On the opposite side, polymer 1 is then applied evenly at 50 g/m², with drying again at 100° C. for 10 minutes.

### Example 2

A Meyer bar is used to apply the coating composition 1 evenly to the non-metallized side of a 38 μm PET film extruded with white pigments as filler, from Toray (Lumirror™ 38E20) and aluminized on one side, and the applied coating is dried at 120° C. for 10 minutes. The application weight is 10 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. On the opposite side (metallic side), polymer 1 is then applied evenly at 50 g/m², with drying again at 100° C. for 10 minutes.

### Example 3

A Meyer bar is used to apply the coating composition 1 evenly to the non-metallized side of the 12 μm PET film, and the applied coating is dried at 120° C. for 10 minutes. The application weight is 12 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. On the opposite side, polymer 1 is then applied evenly at 50 g/m², with drying again at 100° C. for 10 minutes.

### Example 4

A Meyer bar is used to apply the coating composition 1 evenly to the non-metallized side of a 38 μm PET film extruded with white pigments as filler, from Toray (Lumirror™ 38E20) and aluminized on one side, and the applied coating is dried at 120° C. for 10 minutes. The application weight is 15 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. On the opposite side, polymer 1 is then applied evenly at 50 g/m², with drying again at 100° C. for 10 minutes.

### RESULTS

Example 1 is an example of the inventive version of the use of two metallic layers for light absorption and for light reflection.

Examples 2-4 use only one metallic side for light reflection.

Examples 1 and 3 are examples of the use of a thin transparent film, Examples 2 and 4 an example of the use of a relatively thick, white PET film.

Examples 1 to 4 were tested in accordance with test methods A, B and C. The results are shown in table 1.

| | | | Reflectance | Reflectance |
|---|---|---|---|---|
| | | | (total) | (total) |
| | Transmittance | Pinholes | silver side | white side |
| Example | (Test A) | (Test B) | (Test C) | (Test C) |
| Example 1 | <0.1% | 0 | 86.2% | 70.8% |
| Example 2 | <0.1% | 0 | 86.3% | 72.6% |
| Example 3 | 1.3% | 0 | 86.2% | 71.1% |
| Example 4 | <0.1% | 0 | 86.0% | 73.3% |

From the results in table 1 it is apparent that examples 1 to 4 have outstanding properties in terms of optical defects (absence of pinholes) and transmittance. With test C, furthermore, it was possible to show that examples 1 to 4 not only have light-absorbing properties but also possess very high light-reflecting properties. On the silver-reflecting side, in particular, reflectances of greater than 85% are obtained. However, even on the white side, reflectances of greater than 70% are obtained, although here the diffuse light fraction is higher.

For application in the LCD this means that the light yield in the light channel is significantly increased. Additionally it was possible to show that, for the production of a light-reflecting and light-absorbing tape, it is not absolutely necessary to use a double-sided pressure-sensitive adhesive tape which must be black on one side and light-reflecting (in other words white or metallic) on the other side.

1. A pressure-sensitive adhesive tape, exhibiting light-reflecting and light-absorbing properties, said pressure-sensitive adhesive tape having a top side and a bottom side, and comprising a carrier film, which in turn has a top side and a bottom side, the pressure-sensitive adhesive tape being equipped on both sides with a pressure-sensitive adhesive layer,
wherein, at least between the pressure-sensitive adhesive layer on the bottom side of the pressure-sensitive adhesive tape and the carrier film there is a metallic layer, and, at least between the pressure-sensitive adhesive layer on the top side of the pressure-sensitive adhesive tape and the carrier film, there is a white coating layer.

2. The pressure-sensitive adhesive tape of claim 1, which further comprises a second metallic layer between the pressure-sensitive adhesive layer on the top side of the pressure-sensitive adhesive tape and the carrier film.

3. The pressure-sensitive adhesive tape of claim 2, wherein the second metallic layer is between the carrier film and the white coating layer.

4. The pressure-sensitive adhesive tape of claim 1, wherein at least one of the pressure-sensitive adhesive layers is transparent.

5. The pressure-sensitive adhesive tape of claim 1, wherein at least one of the pressure-sensitive adhesive layers is colored white.

6. The pressure-sensitive adhesive tape of claim 1, wherein the carrier film is transparent.

7. A method comprising bonding parts of an optical liquid-crystal data display with a pressure-sensitive adhesive tape according to claim 1.

8. The method of claim 7, wherein the optical liquid-crystal data display is an LCD glass.

9. A liquid-crystal data display device comprising a pressure-sensitive adhesive tape of claim 1.
